(19) United States
(12) Patent Application Publication
(10) Pub. No.: US 2007/0137508 A1
(43) Pub. Date: Jun. 21, 2007

(54) Printing press having plate locking actuators carried by the frame

(75) Inventor: Sylvain Lepinay, Reze (FR)

Correspondence Address: DAVIDSON, DAVIDSON & KAPPEL, LLC, 485 SEVENTH AVENUE, 14TH FLOOR, NEW YORK, NY, 10018, US

(73) Assignee: GOSS SYSTEMES GRAPHIQUES NANTES, Nantes (FR)

(21) Appl. No.: 11/590,300

(22) Filed: Oct. 31, 2006

(30) Foreign Application Priority Data
Nov. 2, 2005 (FR) 05 11 170
Nov. 2, 2005 (FR) 05 11 167

(51) Int. Cl. B41F 1/28

(52) U.S. Cl. 101/415.1

(57) ABSTRACT

This printing press includes a frame and at least one plate cylinder which extends along a longitudinal axis and which is mounted so as to rotate on the frame in order to be able to rotate about the longitudinal axis thereof. The press includes at least one actuator and the plate cylinder includes at least one plate locking bar which extends within the plate cylinder. At least one portion of the bar can be moved under the action of the actuator between an extracted position for locking and a retracted position for unlocking a plate on the plate cylinder. The actuator is carried by the frame.

This application claims the benefit of French Application No. 05 11170 filed Nov. 2, 2005 and French Application No. 05 11167 filed Nov. 2, 2005, hereby incorporated by reference herein.

### TECHNICAL FIELD

The present invention relates to a printing press of the type comprising a frame and at least one plate cylinder which extends along a longitudinal axis and which is mounted so as to rotate on the frame in order to be able to rotate about the longitudinal axis thereof.

The invention is used, for example, in an offset printing press.

### BACKGROUND

The document US-2002/0 148 373 describes a press of the above-mentioned type.

In this press, as in a number of presses, the plate locking actuators are pneumatic cylinders which are arranged at the sides of the plate cylinder and which are carried thereby.

### SUMMARY OF THE INVENTION

The present invention relates to a printing press of the type comprising a frame and at least one plate cylinder which extends along a longitudinal axis and which is mounted so as to rotate on the frame in order to be able to rotate about the longitudinal axis thereof, the press comprising at least one actuator and the plate cylinder comprising at least one plate locking bar which extends within the plate cylinder, at least one portion of the bar being able to be moved under the action of the actuator between an extracted position for locking and a retracted position for unlocking a plate on the plate cylinder.

The service and maintenance of cylinders of this type are particularly complex operations since the cylinders are accessible only with difficulty.

An object of the invention is to overcome this problem by providing a press which can be more readily maintained at a lower cost.

To this end, the invention provides a press wherein the actuator is carried by the frame.

According to specific embodiments, the press may include one or more of the following features, taken in isolation or according to any technically possible combination:

the portion of the locking bar may be rotatably moved between the extracted locking position and the retracted unlocking position thereof;

the cylinder may include an arm for rotatably driving the portion of the locking bar, the driving arm being fixedly joined to the portion in terms of rotation and being intended to co-operate with the actuator;

the driving arm may co-operate with the actuator via an abutment which is carried by the frame and which can be moved by the actuator between a position in which it abuts the driving arm and a position in which it is disengaged from the driving arm; and

the press may be an offset printing press.

### BRIEF DESCRIPTION OF THE FIGURES

The invention will be better understood from a reading of the following description, given purely by way of example and with reference to the appended Figures, in which:

FIG. 1 is a partial, schematic side view of a press according to the invention,

FIG. 2 is a perspective, schematic view of a plate cylinder of the press of FIG. 1,

FIG. 3 is a partial, schematic sectioned view, taken along line III-III of FIG. 2, illustrating a portion of a locking bar of the cylinder of FIG. 2,

FIG. 4 is a schematic front view of a portion of a locking bar of the plate cylinder of FIG. 2,

FIG. 5 is a partial, schematic front view of the press of FIG. 2,

FIGS. 6 to 9 illustrate successive steps of a method for positioning a plate on the plate cylinder of FIG. 2,

FIGS. 10 and 11 are schematic views illustrating successive steps of a method for removing a plate from the plate cylinder of FIG. 2.

### DESCRIPTION OF A PREFERRED EMBODIMENT

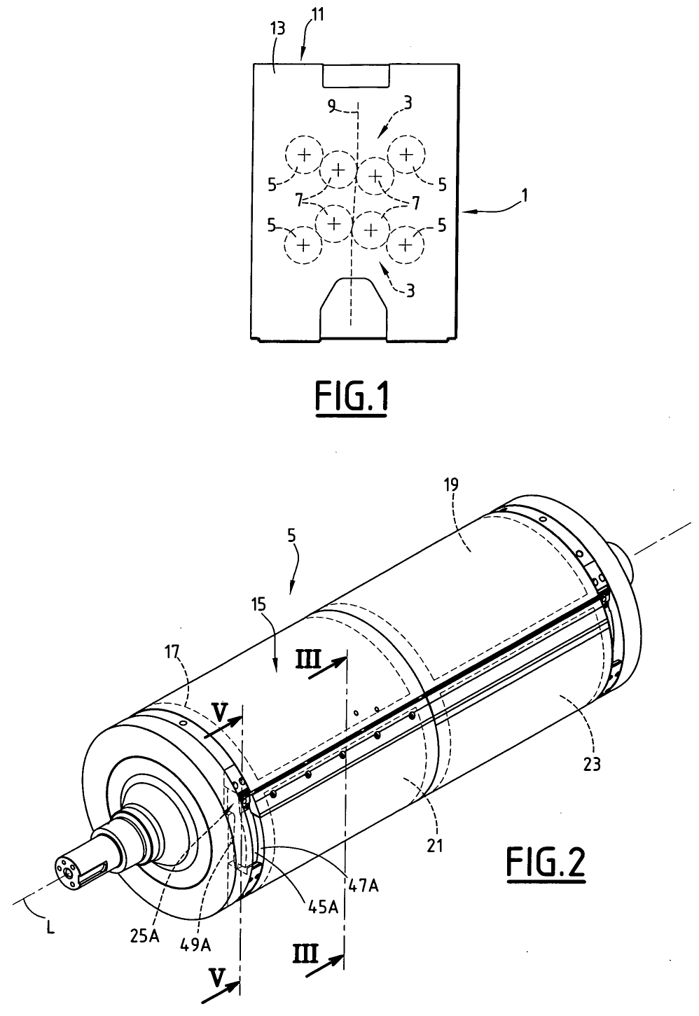

FIG. 1 schematically illustrates an offset printing press 1. In the example illustrated, the press 1 includes two dual printing groups 3 which are arranged one above the other. Each printing group 3 includes two pairs of plate cylinders 5 and blanket cylinders 7.

The blanket cylinders 7 of the same printing group 3 are, during operation of the press 1, pressed one against the other and a web 9 of paper travels vertically between the blanket cylinders 7 of the two groups.

The plate cylinders 5 and blanket cylinders 7 are rotatably received in a frame 11 which typically includes two lateral walls 13 between which the cylinders 5 and 7 extend longitudinally. In this manner, the cylinders 5 and 7 can rotate about their respective longitudinal axes in order to carry out the various functions of the press.

The plate cylinders 5 have similar structures so that only one will be described below.

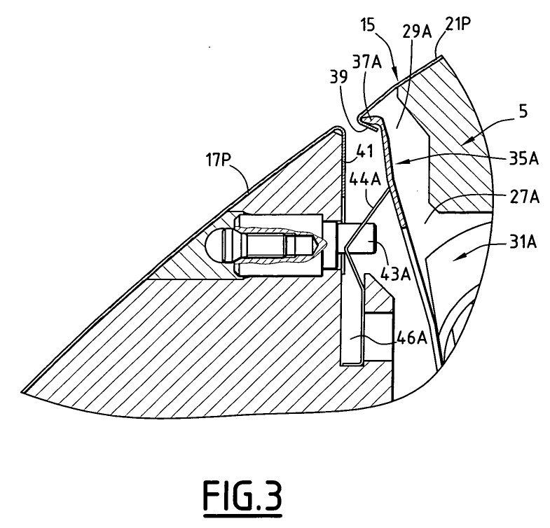

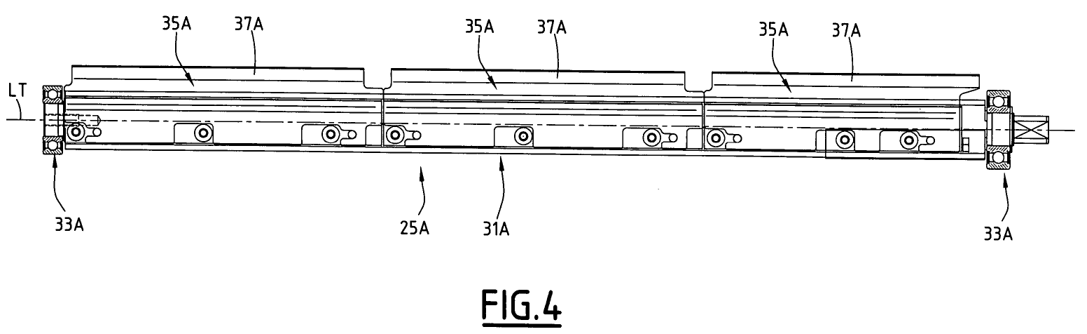

As illustrated in FIG. 2, the outer surface 15 of the cylinder 5 includes four regions 17, 19, 21, 23, indicated with dashed lines in FIG. 2. Each region 17, 19, 21 and 23 is intended to receive a plate 17P, 19P, 21P, 23P, respectively. The plates 17P and 21P have been illustrated in FIG. 3.

The first region 17 and the second region 19 are arranged one beside the other along the longitudinal axis L of the cylinder 5. The third region 21 and the fourth region 23 are arranged transversely beside the first region 17 and the second region 19, respectively. In the example of FIG. 2, in which the cylinder 5 is intended to receive four plates, the regions 17 and 21 at one side and 19 and 23 at the other side are therefore diametrically opposed relative to the axis L.

The dimensions of the regions 17, 19, 21 and 23 are, for example, such that they can receive plates 17P, 19P, 21P and 23P which are each intended to print, for example, a page in broadsheet format arranged vertically or two pages in tabloid format arranged horizontally one above the other.

The cylinder 5 is equipped with two locking bars 25A and 25B which extend longitudinally inside the cylinder 5. Only the left-hand end of the bar 25A can be seen in FIG. 2.

The two bars 25A and 25B are arranged in a substantially diametrically opposed manner relative to the longitudinal axis L and have similar structures. Only the structure of the bar 25A will thus be described below.

The bar 25A is arranged in a housing 27A which is arranged longitudinally in the cylinder 5 close to the outer surface 15 thereof. The housing 27A opens in the outer surface 15 via an aperture 29A and the locking bar 25A includes two portions 31A which are arranged successively one beside the other along the longitudinal axis L.

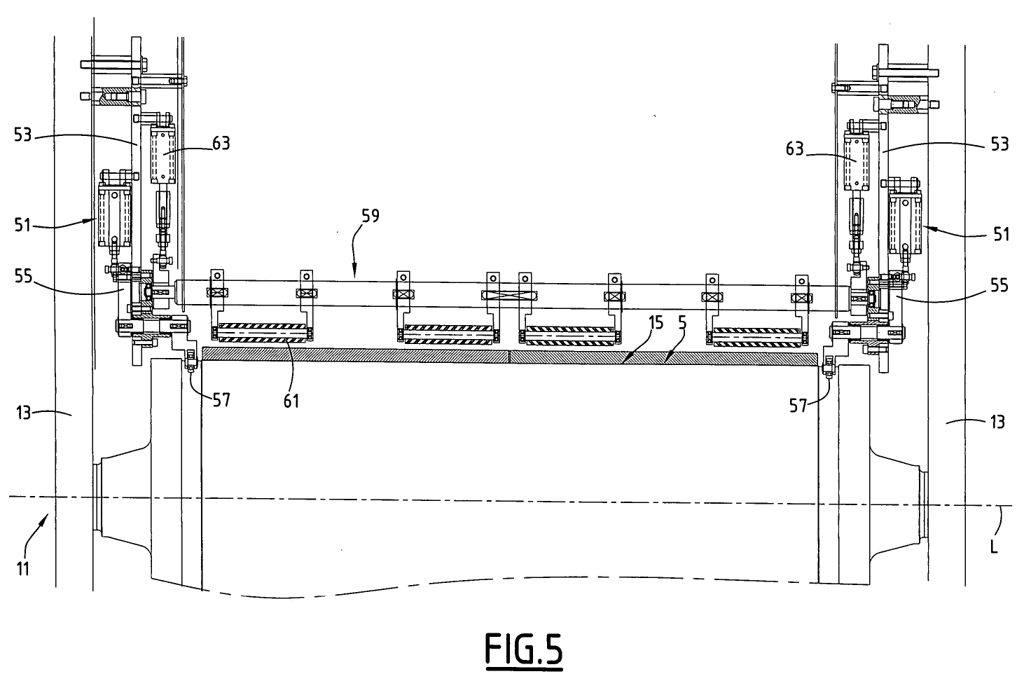

FIG. 4 illustrates the left-hand portion 31A which will be described below, the right-hand portion 31B having a symmetrical structure relative to a vertical centre plane of the press. The left-hand portion 31A is mounted so as to rotate in the housing 27A of the cylinder 5 owing to roller bearings 33A which are provided at the longitudinal ends of the portion 31A. In this manner, the left-hand portion 31A can rotate about the axis LT thereof relative to the cylinder 5.

The portion 31A is provided, for example, with three traction blades 35A which are arranged successively one beside the other along the longitudinal axis LT of the portion 31A.

The blades 35A have their free ends 37A folded in order to form hooks. These hooks 37A are intended to pull the rear edge 39 of the corresponding plate, in this case the plate 21P (FIG. 3). In conventional manner, this rear edge 39 is folded inwards in order to be received in the aperture 29A. In the same manner, the front edge 41 of each plate, and in particular the plate 17P which can be seen in FIG. 3, is folded inwards in order to be engaged in the corresponding aperture, in this instance the aperture 29A in FIG. 3.

A pin 43A which protrudes inside the aperture 29A is received in an opening which is provided in the front edge 41 of the plate 17P, in order to ensure correct positioning thereof. A spring 44A is fixed in a groove 46A via a pin. The spring 44A presses on the edge 41A in order to apply it against the left-hand wall (in FIG. 3) of the aperture 29A.

The left-hand portion 31A can be rotatably moved about the longitudinal axis LT thereof between an extracted locking position, illustrated in FIG. 3, and a retracted unlocking position. In the locking position, the hooks 37A are engaged behind the rear edge 39 of the plate 21P and pull it circumferentially in the counter-clockwise direction in FIG. 3.

Since the plate 21P is further retained by the front edge 41 thereof which is engaged in the other aperture 29B of the cylinder 5, the plate 21P is thus tensioned and locked.

In order to move into the unlocking position thereof, the portion 31A rotates about the longitudinal axis LT thereof in the clockwise direction in FIG. 3, thereby disengaging the hooks 37A of the rear edge 39 and allowing the plate 21P to be withdrawn.

A displacement arm 45A is fixedly joined to the outer longitudinal end of the left-hand portion 31A. This arm 45A is received in a recess 47A which is provided in the cylinder 5. Since the arm 45A is fixedly joined to the left-hand portion 31A in terms of rotation, it can therefore be rotatably moved about the longitudinal axis LT of the portion 31A between an extracted position and a retracted position.

A compression spring 49A (FIG. 2) interposed between the cylinder 5 and the arm 45A returns the arm 45A into the extracted position thereof.

The two portions 31A of the bar 25A can be moved independently of each other, via their respective arms 45A, in order to reach their respective positions for locking and unlocking.

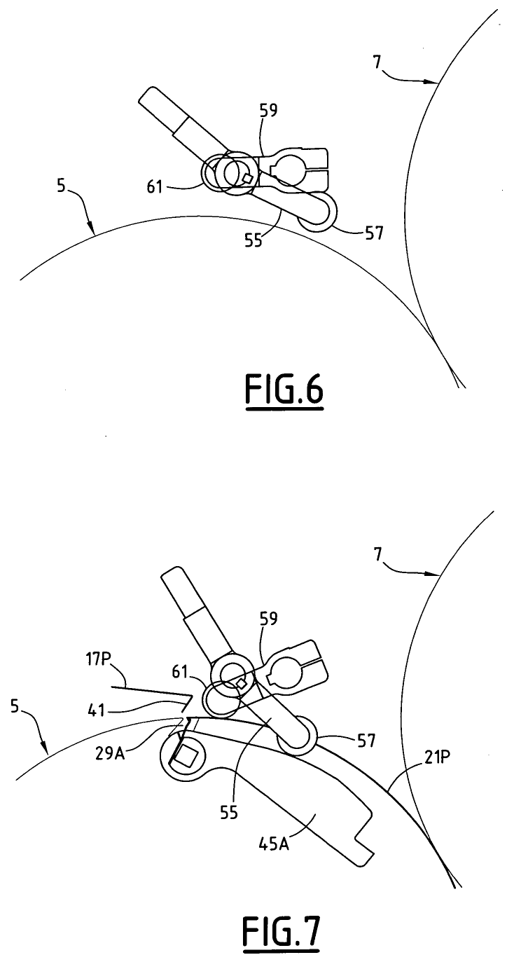

In order to control the movements of the portions 31A and 31B of the two locking bars 25A and 25B, the press 1 includes two actuators 51 (FIG. 5) which are each carried by the corresponding fixed lateral wall 13 of the frame 11. More precisely, each actuator 51 is mounted on a support 53 which is fixedly joined to the corresponding lateral wall 13.

The actuators 51 are, for example, pneumatic jacks. The rods thereof are connected to levers 55 which are mounted so as to pivot on the supports 53. The rod of each jack 51 is connected to one of the ends of the corresponding lever 55, the other end of the lever 55 carrying a roller 57 which presses on the corresponding arms 45A and 45B.

Each roller 57 can thus be moved, under the action of the corresponding actuator 51, between a position in which it presses on the arm 45A or the arm 45B and a position in which it is disengaged from the corresponding arms 45A and 45B.

In the pressing position thereof, the roller 57 is moved radially closer to the longitudinal axis L of the cylinder 5. If an arm 45A or 45B is located opposite the roller 57, the roller 57 is pressed on this arm which is then in the retracted position.

In the released position thereof, the roller 57 is further removed from the longitudinal axis A and cannot interfere with an arm 45A or 45B.

As illustrated in FIG. 5, the press 1 further includes a plate retention bar 59 which extends longitudinally above the entire length of the surface 15 of the cylinder 5.

This bar 59 is provided with rollers 61 which are intended to press the plates 17P, 19P, 21P and 23P against the outer surface 15 of the cylinder 5, as will be described below.

The bar 59 is articulated to the supports 53 in order to be able to be moved between a position remote from the cylinder 5 and a position close to the cylinder 5.

In the close position, the rollers 61 press either on the surface 15 of the cylinder 5 or on plates which are arranged thereon. In the remote position, the rollers 61 are remote from the outer surface 15 and the plates which it could carry.

The movement of the retention bar 59 between the two positions thereof is carried out via actuators 63 which are, for example, pneumatic jacks.

The operation of these actuators 63 is synchronised, in contrast to that of the actuators 51 which can independently control the movement of the portions 31A and 31B of the same locking bar 25A or 25B, as will be seen below.

The operation of the actuators 51 and 63 is controlled by a control unit, for example, an electronic one, in order to carry out the functions described below.

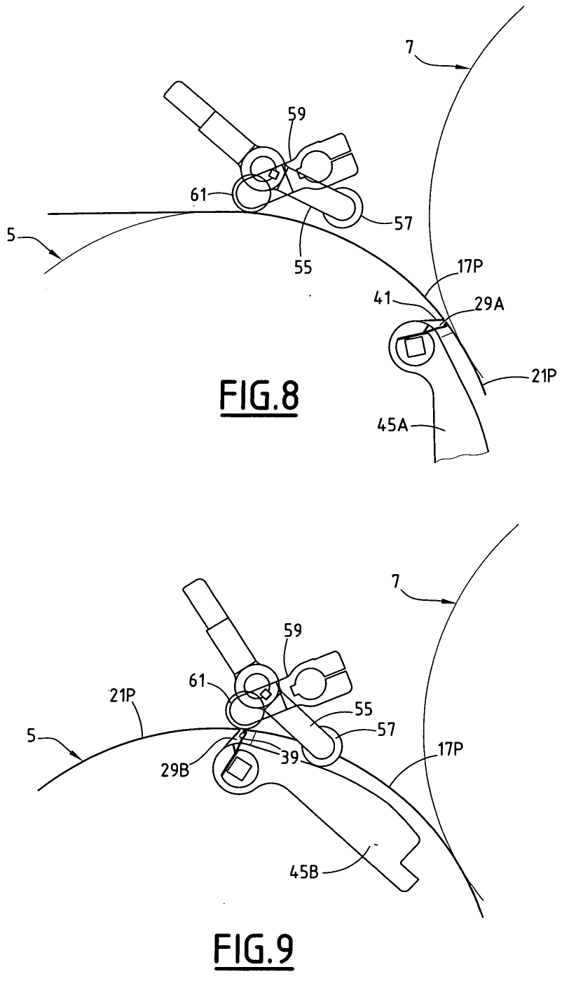

FIGS. 6 to 10 illustrate in particular various steps of a method for positioning a plate on the plate cylinder 5. In the example described, this is the plate 17P.

In FIG. 6, the roller 57 concerned, that is to say, the left-hand roller 57, is in a released position and the retention bar 59 is in the remote position. The locking bars 25A and 25B are in a locking position. The plate cylinder 5 does not occupy a specific angular position.

When an operator decides to position a new plate 17P on the cylinder 5, he begins to carry out the corresponding operation using the control unit. This automatically brings about the rotational driving of the plate cylinder 5 until the locking arm 45A is moved substantially opposite the left-hand roller 57. The retention bar 59 is then automatically brought into a close position so that the rollers 61 press on the plate 21P, if it is present, or on the outer surface 15 of the cylinder 5.

Then, the roller 57 is automatically brought into a position in which it presses on the arm 45A, moving the arm into a retracted position (FIG. 7). The left-hand portion 31A of the bar 25A then moves into the unlocked position. The rear edge 39 of the plate 21P, if it is present on the cylinder 5, is held in position by the rollers 61.

An operator then manually engages the front edge 41 of the plate 17P in the aperture 29A where it will be held by the pin 43A and the spring 44A. The operator then confirms, for example, by pressing on a button, that the front edge 41 really has been engaged in the aperture 29A.

The control unit automatically controls the rotation of the cylinder 5 in the clockwise direction in FIG. 7 until the rollers 61 are located in alignment with the aperture 29A. The left-hand roller 57 is then brought into a disengaged position and the left-hand portion 31A (in FIG. 2) returns into a locking position so that the rear edge 39 of the plate 21P is held by the left-hand portion 31A.

The rotation of the plate cylinder 5 in the clockwise direction may then continue approximately over a half-turn, the rollers 61 and the associated blanket cylinder 7 moving and progressively pressing the plate 17P on the region 17 of the outer surface 15 of the cylinder 5, as illustrated in FIG. 8.

When approaching the aperture 29B, the rotation of the cylinder 5 is automatically stopped and the left-hand roller 57 is automatically moved into a position in which it presses on the left-hand arm 45B and the left-hand portion 31B moves into the unlocking position. The rotation of the cylinder 5 automatically resumes and the rollers 61 progressively insert the rear edge 39 of the plate 17P in the aperture 29B (FIG. 9). The rotation of the cylinder 5 stops automatically when the rollers 61 are located in alignment with the aperture 29B and the left-hand roller 57 is automatically brought into the disengaged position. The left-hand arm 45B is then returned to the extracted position, so that the left-hand portion 31B locks the rear edge 39 of the plate 17P. The plate is then correctly locked and the retention bar 59 can automatically return into a remote position. The positioning of the plate 17P is complete.

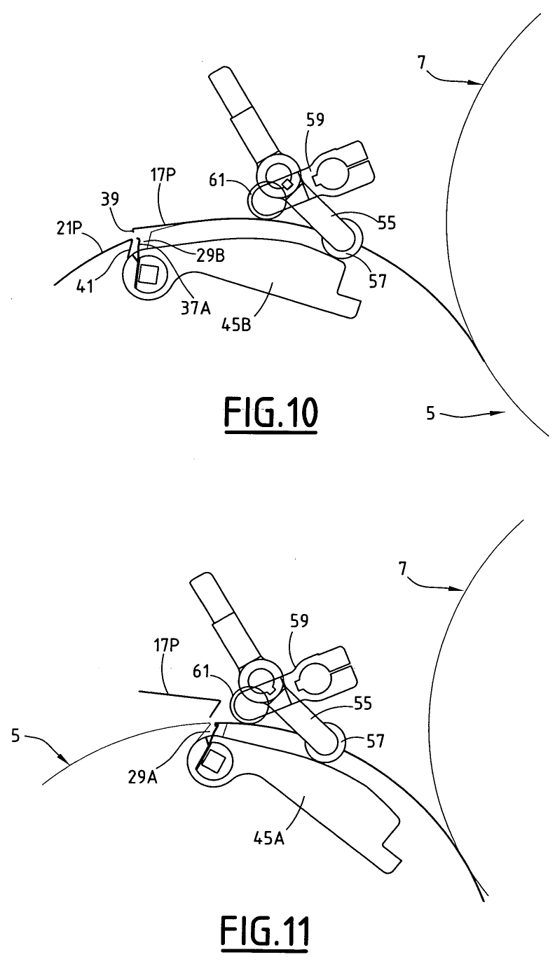

A method for removing the same plate 17P will now be described with reference to FIGS. 10 and 11.

Starting from a situation similar to that of FIG. 6, the operator, for example, by pressing on a button, begins to carry out the removal operation under the control of the control unit. This automatically rotatably drives the cylinder 5 until the left-hand arm 45B is moved opposite the left-hand roller 57. The rollers 61 are then automatically brought into a position in which they press on the plate 17P and then the left-hand roller 57 is automatically brought into a position in which it presses on the left-hand arm 45B, thus bringing about the unlocking of the left-hand portion 31B. Owing to the resilient nature of the plate 17P, the rear edge 39 thereof disengages from the aperture 29B but the remainder of the plate 17P is held in place at one side by the associated blanket cylinder 7 and, at the other side, by the rollers 61 (FIG. 10).

The left-hand roller 57 is then automatically brought into a disengaged position, causing the left-hand portion 31B to be locked again, then the cylinder 5 is automatically rotatably driven in the counter-clockwise direction, bringing about the progressive movement of the plate 17P of the cylinder 5, until the aperture 29A is accessible (FIG. 11).

The left-hand roller 57 is then automatically brought into a position in which it presses on the left-hand arm 45A, bringing about the movement of the left-hand portion 31A into the unlocking position. The rear edge 39 of the plate 21P, if it is present on the cylinder 5, is then held in position by the rollers 61. An operator can then withdraw the front edge 41 of the plate 17P from the aperture 29A.

Once the operator has confirmed the withdrawal of the front edge 41 of the plate 17P, the control unit automatically rotatably drives the cylinder 5 slightly in the clockwise direction until the rollers 61 are located in alignment with the aperture 29A. The left-hand roller 57 is then automatically moved towards the disengaged position thereof, causing the left-hand portion 31A of the locking bar 25A to be locked again. Finally, the retention bar 59 is automatically moved towards the remote position thereof. The withdrawal of the plate 17P is then complete.

Since the locking bars 25A and 25B are constructed in several portions 31A and 31B which can be moved independently of each other, the positioning or the withdrawal of a plate at the left-hand side can be carried out without having to position or withdraw the plates mounted at the right-hand side of the cylinder 5.

In the same manner, the positioning or removal of a plate which is provided at one side of the cylinder 5, for example, the plate 17P in the example described above, can be carried out without having any impact on the other plate 21P mounted at the same side.

A plate can thus be changed independently of other plates which are present on the cylinder 5, which allows a change of formatting to be carried out. Furthermore, it should be noted that the removal of a plate can be carried out without damaging the plate.

It should be noted that the plate positioning and removal methods described above are semi-automatic methods.

Since the locking bars 25A and 25B are produced in several portions 31A and 31B, the positioning and removal of a plate can also be carried out simply in a completely manual manner.

The positioning and the removal are carried out as described above for the plate 17P, apart from the fact that the locking and unlocking of the portion 31A and the rotatable driving of the plate cylinder 5 are controlled by the operator.

The operator holds the plate 17P in a tensioned state during the positioning or removal operation, thus providing the function of the rollers 61.

It may be necessary to implement such manual positioning or removal methods in the case of damage.

Advantageously, as in the example described above, it is possible to pivot the plate cylinder 5 over a short angular range whilst retaining the locking bars 25A and/or 25B in an unlocked position by pressing the rollers 57 on the arms 45A and 45B.

It should be noted that, even in the case of manual implementation, it is possible to change only some plates. The unlocking and locking of the left-hand portions 31A and 31B in the example of the plate 17P does not bring about that of the right-hand portions 31A and 31B of the same locking bars. In this manner, when the plate 17P is positioned or removed, it is not necessary to manually retain the plates 19P and 23P which are provided at the right-hand side of the cylinder.

The manual method for changing plates can then be carried out by a single operator.

Furthermore, it should be noted that the actuators 51 used to move the locking bars 25A and 25B are carried by the frame 11 and not by the plate cylinders 5 themselves. The maintenance of these actuators 51 may be thereby facilitated and economical, and the costs involving the plate cylinders 5 may be reduced.

It should be noted that this last feature, relating to the use of actuators 51 which are carried by the frame 11 rather than the cylinders 5, may be used independently of locking bars 25A and 25B in several portions.

The principles described above may relate to plate cylinders 5 which have different dimensions to those described above, and which may have different numbers of plates.

They may thus relate to cylinders which receive only one plate on the circumference.

In such a case, the cylinder is provided with a single locking bar 25.

Configurations other than those described above may be used in the context of the invention, for example, presses with horizontal paper feeding, which use printing groups other than dual printing groups.

What is claimed is:

1-7. (canceled)

8. A printing press comprising:
a frame;
at least one plate cylinder extending along a longitudinal axis and rotatably mounted on the frame with respect to the longitudinal axis;
at least one actuator supported by the frame; and
a roller supported by the frame;
the plate cylinder including at least one plate locking bar extending within the plate cylinder and a driving arm rotatably driving at least one portion of the plate locking bar,
the actuator moving the at least one portion between an extracted position for locking and a retracted position for unlocking a plate on the at least one plate cylinder,
the driving arm being rotationally fixed to the at least one portion and operatable with the actuator via the roller,
the actuator moving the roller between a position abutting the driving arm and a position disengaging the driving arm.

9. The printing press as recited in claim 8 wherein the at least one portion of the locking bar is rotatably moved between the extracted locking position and the retracted unlocking position.

10. The printing press as recited in claim 8 wherein the plate cylinder includes an outer surface having at least a first region receiving a first plate and a second region receiving a second plate, the first region being arranged adjacent to the second region along the longitudinal axis of the plate cylinder, and the plate locking bar includes at least a first portion extending opposite the first region and a second portion extending opposite the second region, the first and second portions being independently movable between the extracted position for locking and the retracted position for unlocking the first and second plates, respectively.

11. The printing press as recited in claim 10 wherein the outer surface further includes at least a third region and a fourth region receiving a third plate and a fourth plate, respectively, the third region arranged adjacent to the fourth region along the longitudinal axis of the plate cylinder, the third region and fourth region transversely arranged adjacent to the first region and the second region, respectively, and the plate cylinder further includes a second locking bar, the second locking bar including at least a third portion extending opposite the third region, and a fourth portion extending opposite the fourth region, the third and the fourth portions being independently movable between the extracted position for locking and the retracted position for unlocking the third and fourth plates, respectively.

12. The printing press as recited in claim 10 wherein the at least first and second portions of the plate locking bar are portions for traction of rear edges of the first and second plates.

13. The printing press as recited in claim 12 wherein the at least first and second portions of the plate locking bar include at least one hook engaging behind a folded rear edge of the first and second plates.

14. The printing press as recited in claim 8 wherein the printing press is an offset printing press.
